(19) United States
(12) Patent Application Publication
(10) Pub. No.: US 2022/0362618 A1
(43) Pub. Date: Nov. 17, 2022

(54) QUICK RELEASING DEVICE AND WEIGHT APPARATUS

(71) Applicant: Lung-Fei CHUANG, Taichung City (TW)

(72) Inventor: Lung-Fei CHUANG, Taichung City (TW)

(21) Appl. No.: 17/445,406

(22) Filed: Aug. 19, 2021

(30) Foreign Application Priority Data
May 13, 2021 (TW) 110205438

(51) Int. Cl. A63B 21/072

(52) U.S. Cl. CPC A63B 21/0728

(57) ABSTRACT

A quick releasing device includes a housing, a first detent structure, a second detent structure, a first elastic member and a second elastic member. The housing has a through hole and two openings located on two sides of the housing, respectively. The first detent structure includes a first engaging portion and a first abutting portion. The first abutting portion is connected to the first engaging portion. The second detent structure includes a second engaging portion and a second abutting portion. The second engaging portion forms an engaging space with the first engaging portion. The engaging space is corresponding to the through hole. The second abutting portion is connected to the second engaging portion. The first elastic member is telescopically connected between the first engaging portion and the second abutting portion. The second elastic member is telescopically connected between the second engaging portion and the first abutting portion.

### RELATED APPLICATIONS

This application claims priority to Taiwan Application Serial Number 110205438 filed on May 13, 2021, which is herein incorporated by reference.

### BACKGROUND

### Technical Field

The present disclosure relates to a quick releasing device. More particularly, the present disclosure relates to a quick releasing device that can be quickly assembled on and disassembled from a weight apparatus.

### Description of Related Art

At present, many quick releasing devices have been introduced in the market to meet different needs. In particular, in order to meet the needs of users in weight training, a training equipment is often equipped with a quick releasing device for the user to adjust the load weight of the training equipment. Although a conventional quick releasing device can help the user adjust the load weight of the training equipment, it cannot be stably engaged with the training equipment so as to cause weight members to shake and make the user feel uncomfortable during training. Moreover, in order to stably engage the quick releasing device on the training equipment, the user must require a lot of effort to disassemble the quick releasing device from the training equipment to adjust the load weight of the training equipment, thereby resulting in unnecessary physical strength consumption and waste of time.

Therefore, a quick releasing device which can be stably and quickly engaged with a target object is commercially desirable.

### SUMMARY

According to one aspect of the present disclosure, a quick releasing device includes a housing, a first detent structure, a second detent structure, a first elastic member and a second elastic member. The housing has a through hole and two openings. The two openings are located on two sides of the housing, respectively. The first detent structure is disposed in the housing and includes a first engaging portion and a first abutting portion. The first abutting portion is connected to the first engaging portion and corresponding to one of the two openings of the housing. The second detent structure is disposed in the housing and includes a second engaging portion and a second abutting portion. The second engaging portion forms an engaging space with the first engaging portion. The engaging space is corresponding to the through hole. The second abutting portion is connected to the second engaging portion and corresponding to another of the two openings of the housing. The first elastic member is telescopically connected between the first engaging portion and the second abutting portion. The second elastic member is telescopically connected between the second engaging portion and the first abutting portion.

According to another aspect of the present disclosure, a weight apparatus includes a shaft member, at least one quick releasing device, at least one positioning member and a plurality of weight members. The at least one quick releasing device is detachably disposed on the shaft member and includes a housing, a first detent structure, a second detent structure, a first elastic member and a second elastic member. The housing has a through hole and two openings. The two openings are located on two sides of the housing, respectively, and the shaft member is passed through the through hole. The first detent structure is disposed in the housing and includes a first engaging portion and a first abutting portion. The first abutting portion is connected to the first engaging portion and corresponding to one of the two openings of the housing. The second detent structure is disposed in the housing and includes a second engaging portion and a second abutting portion. The second engaging portion forms an engaging space with the first engaging portion. The engaging space is corresponding to the through hole. The second abutting portion is connected to the second engaging portion and corresponding to another of the two openings of the housing. The first elastic member is telescopically connected between the first engaging portion and the second abutting portion. The second elastic member is telescopically connected between the second engaging portion and the first abutting portion. The at least one positioning member is disposed on the shaft member and corresponding to the at least one quick releasing device. The weight members are detachably disposed on the shaft member and located between the at least one positioning member and the at least one quick releasing device.

According to further another aspect of the present disclosure, a weight apparatus includes a base, a cover, a grip rod, a shaft member, a quick releasing device and a plurality of weight members. The cover detachably covers the base and forms an accommodating space with the base. The grip rod is passed through the cover and connected to the base. The shaft member is fixed to the base and located in the accommodating space. The quick releasing device is located in the accommodating space and detachably disposed on the shaft member. The quick releasing device includes a housing, a first detent structure, a second detent structure, a first elastic member and a second elastic member. The housing has a through hole and two openings. The two openings are located on two sides of the housing, respectively, and the shaft member is passed through the through hole. The first detent structure is disposed in the housing and includes a first engaging portion and a first abutting portion. The first abutting portion is connected to the first engaging portion and corresponding to one of the two openings of the housing. The second detent structure is disposed in the housing and includes a second engaging portion and a second abutting portion. The second engaging portion forms an engaging space with the first engaging portion. The engaging space is corresponding to the through hole. The second abutting portion is connected to the second engaging portion and corresponding to another of the two openings of the housing. The first elastic member is telescopically connected between the first engaging portion and the second abutting portion. The second elastic member is telescopically connected between the second engaging portion and the first abutting portion. The weight members are located in the accommodating space and detachably disposed on the shaft member. The weight members are located between the base and the quick releasing device.

### BRIEF DESCRIPTION OF THE DRAWINGS

The present disclosure can be more fully understood by reading the following detailed description of the embodiment, with reference made to the accompanying drawings as follows:

FIG. 1 shows a schematic view of a quick releasing device according to a first embodiment of the present disclosure.

FIG. 2 shows an exploded view of the quick releasing device of FIG. 1.

FIG. 3 shows a top view of a first detent structure, a second detent structure, a first elastic member and a second elastic member of FIG. 1 in one operating state.

FIG. 4 shows a top view of the first detent structure, the second detent structure, the first elastic member and the second elastic member of FIG. 1 in another operating state.

FIG. 5 shows a perspective schematic view of the one operating state of FIG. 3.

FIG. 6 shows a perspective schematic view of the another operating state of FIG. 4.

FIG. 7 shows a cross-sectional view of the quick releasing device of FIG. 1.

FIG. 8 shows a cross-sectional view of a quick releasing device according to a second embodiment of the present disclosure.

FIG. 9 shows a cross-sectional view of a first detent structure, a second detent structure, a first elastic member and a second elastic member of a quick releasing device in one operating state according to a third embodiment of the present disclosure.

FIG. 10 shows a cross-sectional view of the first detent structure, the second detent structure, the first elastic member and the second elastic member of FIG. 9 in another operating state.

FIG. 11 shows a perspective schematic view of a weight apparatus according to a fourth embodiment of the present disclosure.

FIG. 12 shows an exploded view of the weight apparatus of FIG. 11.

FIG. 13 shows a schematic view of a combination of a first detent structure, a second detent structure, a first elastic member, a second elastic member and a shaft member of FIG. 11.

FIG. 14 shows a partial cross-sectional view of a weight apparatus according to a fifth embodiment of the present disclosure.

FIG. 15 shows another partial cross-sectional view of the weight apparatus of FIG. 14.

FIG. 16 shows a perspective schematic view of a weight apparatus according to a sixth embodiment of the present disclosure.

FIG. 17 shows an exploded view of the weight apparatus of FIG. 16.

FIG. 18 shows a perspective schematic view of a weight apparatus according to a seventh embodiment of the present disclosure.

FIG. 19 shows an exploded view of the weight apparatus of FIG. 18.

FIG. 20 shows a partial cross-sectional view of the weight apparatus of FIG. 18.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “connected to” another element, it can be directly connected to the other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

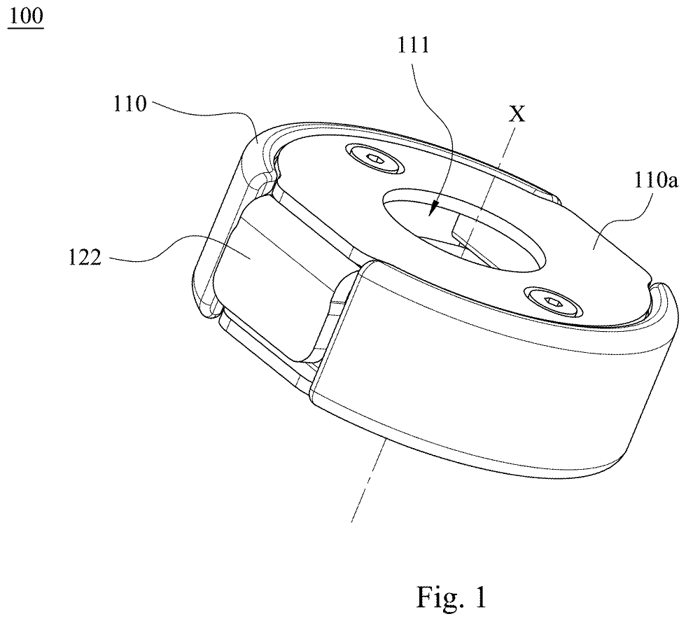

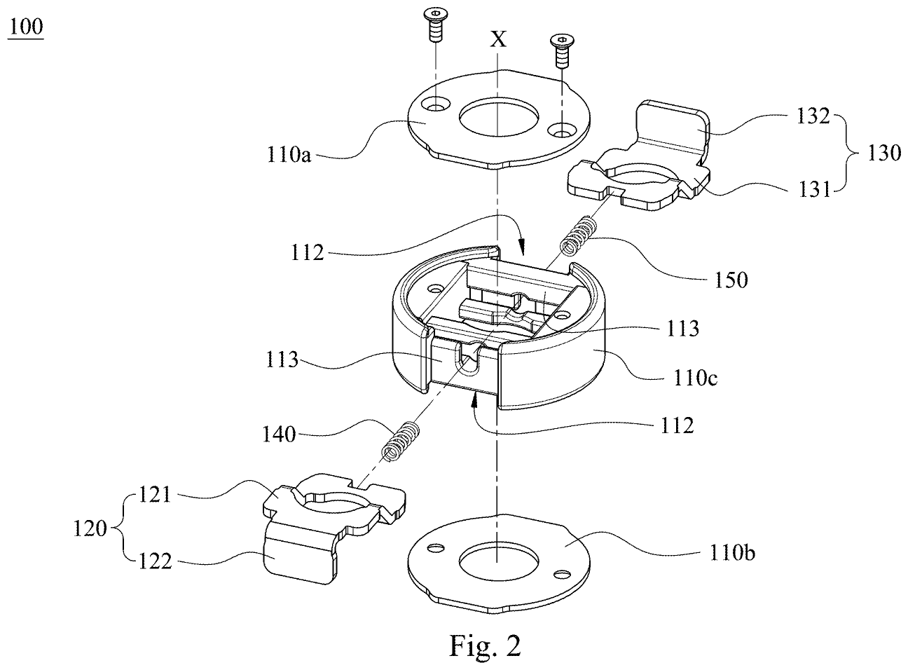

FIG. 1 shows a schematic view of a quick releasing device 100 according to a first embodiment of the present disclosure. FIG. 2 shows an exploded view of the quick releasing device 100 of FIG. 1. In FIGS. 1 and 2, the quick releasing device 100 includes a housing 110, a first detent structure 120, a second detent structure 130, a first elastic member 140 and a second elastic member 150. The housing 110 has a central axis X, a through hole 111 and two openings 112. The central axis X is passed through the through hole 111. The two openings 112 are located on two sides of the housing 110, respectively. The first detent structure 120 is disposed in the housing 110 and includes a first engaging portion 121 and a first abutting portion 122. The first abutting portion 122 is connected to the first engaging portion 121 and corresponding to one of the two openings 112 of the housing 110. The second detent structure 130 is disposed in the housing 110 and includes a second engaging portion 131 and a second abutting portion 132. The second engaging portion 131 forms an engaging space with the first engaging portion 121. The engaging space is corresponding to the through hole 111. The second abutting portion 132 is connected to the second engaging portion 131 and corresponding to another of the two openings 112 of the housing 110. The first elastic member 140 is telescopically connected between the first engaging portion 121 and the second abutting portion 132. The second elastic member 150 is telescopically connected between the second engaging portion 131 and the first abutting portion 122.

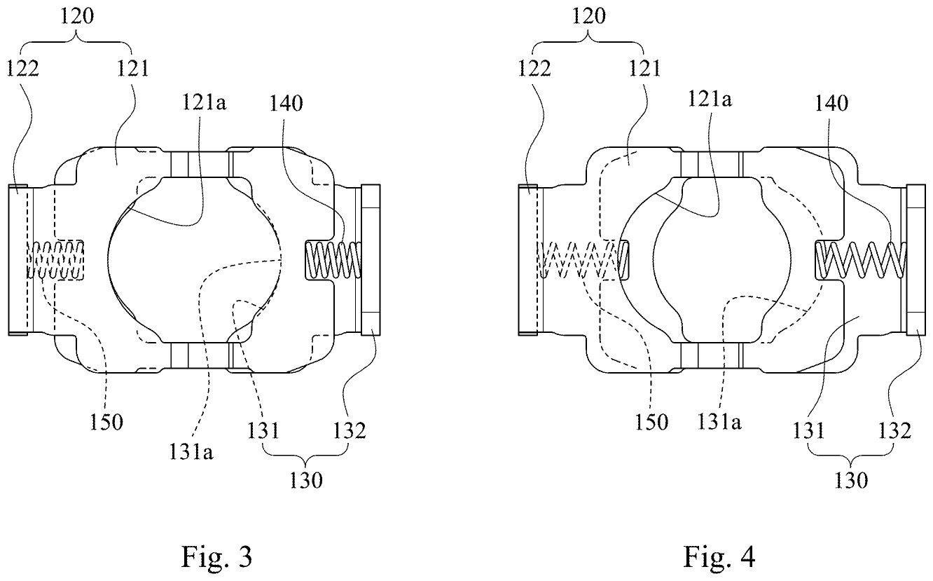

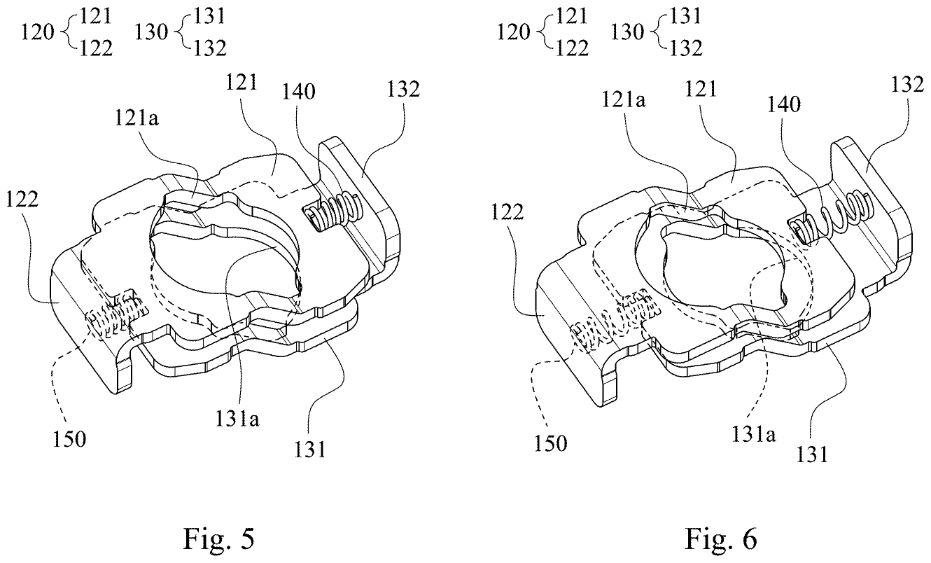

FIG. 3 shows a top view of the first detent structure 120, the second detent structure 130, the first elastic member 140 and the second elastic member 150 of FIG. 1 in one operating state. FIG. 4 shows a top view of the first detent structure 120, the second detent structure 130, the first elastic member 140 and the second elastic member 150 of FIG. 1 in another operating state. FIG. 5 shows a perspective schematic view of the one operating state of FIG. 3. FIG. 6 shows a perspective schematic view of the another operating state of FIG. 4. In FIGS. 1, 2, 3 and 5, when the first detent structure 120 and the second detent structure 130 are disposed on the housing 110, the first abutting portion 122 and the second abutting portion 132 are exposed corresponding to the two opening 112. Hence, when a user pushes against the first abutting portion 122 and the second abutting portion 132 via the two openings 112 of the housing 110, the first elastic member 140 and the second elastic member 150 are compressed to change a relative position of the first engaging portion 121 and the second engaging portion 131, thereby expanding the engaging space for a target object smoothly passing through the engaging space via the through hole 111. The target object can be a shaft member, but the present disclosure is not limited thereto. In FIGS. 4 and 6, when the user releases the first abutting portion 122 and the second abutting portion 132, the first engaging portion 121 and the second engaging portion 131 return to another relative position where the first abutting portion 122 and the second abutting portion 132 are not pushed via an elastic restoring force of each of the first elastic member 140 and the second elastic member 150, thereby reducing the engaging space for the target object engaged between the first engaging portion 121 and the second engaging portion 131. Therefore, the quick releasing device 100 can be stably and quickly engaged with the target object or disassembled from the target object.

Specifically, the first engaging portion 121 and the second engaging portion 131 have holes 121a, 131a, respectively. The hole 121a of the first engaging portion 121 and the hole 131a of the second engaging portion 131 are corresponding to each other to form the engaging space, but the present disclosure is not limited thereto. In detail, when the user pushes the first abutting portion 122 and the second abutting portion 132 toward the central axis X of the quick releasing device 100 simultaneously, the hole 121a of the first engaging portion 121 and the hole 131a of the second engaging portion 131 are corresponding to each other, so that the engaging space is larger than the target object, and the target object can be movably passed through the quick releasing device 100. On the contrary, when the user releases the first abutting portion 122 and the second abutting portion 132, the hole 121a of the first engaging portion 121 and the hole 131a of the second engaging portion 131 are partially staggered, so that the target object is engaged between an inner wall of the hole 121a of the first engaging portion 121 and an inner wall of the hole 131a of the second engaging portion 131.

In FIG. 2, the housing 110 may include two housing plates 110a, 110b and a housing body 110c. The two housing plates 110a, 110b can be screwed to the housing body 110c, but the present disclosure is not limited thereto. Therefore, the first detent structure 120 and the second detent structure 130 can be prevented from loosening.

In FIG. 2, the first engaging portion 121 and the first abutting portion 122 are integrally formed to form the first detent structure 120, and the second engaging portion 131 and the second abutting portion 132 are integrally formed to form the second detent structure 130, but the present disclosure is not limited thereto. Therefore, the structural strength of the first detent structure 120 and the second detent structure 130 can be enhanced.

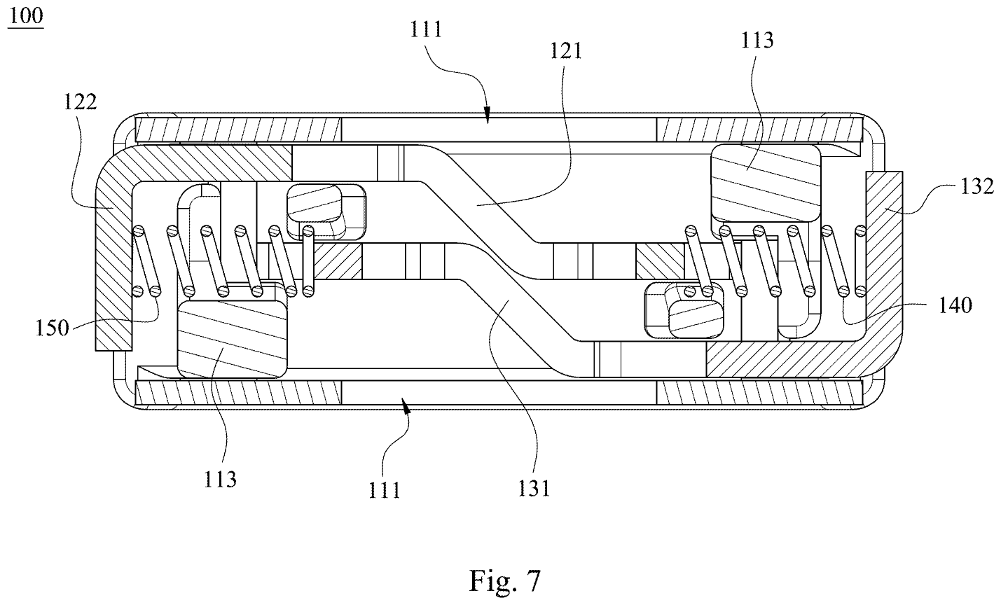

FIG. 7 shows a cross-sectional view of the quick releasing device 100 of FIG. 1. In FIGS. 2 and 7, the first engaging portion 121 and the second engaging portion 131 have an inclined structure and are corresponding to each other. When the target object is engaged between the first engaging portion 121 and the second engaging portion 131, the inclined structure can enable the first engaging portion 121 and the second engaging portion 131 to abut against each other, thereby lowering the stress of the target object when being engaged and reducing wear of the target object.

In FIG. 7, the housing 110 may include two stopping structures 113. One of the two stopping structures 113 is located between the first abutting portion 122 and the through hole 111, and another of the two stopping structures 113 is located between the second abutting portion 132 and the through hole 111. As an example of the first abutting portion 122, when the first abutting portion 122 is pushed and moved toward the central axis X to compresses the second elastic member 150, one of the two stopping structures 113 can limit the distance that the first abutting portion 122 is moved toward the central axis X, thereby preventing the first abutting portion 122 from excessively compressing the second elastic member 150 and reducing the possibility of elastic fatigue of the second elastic member 150.

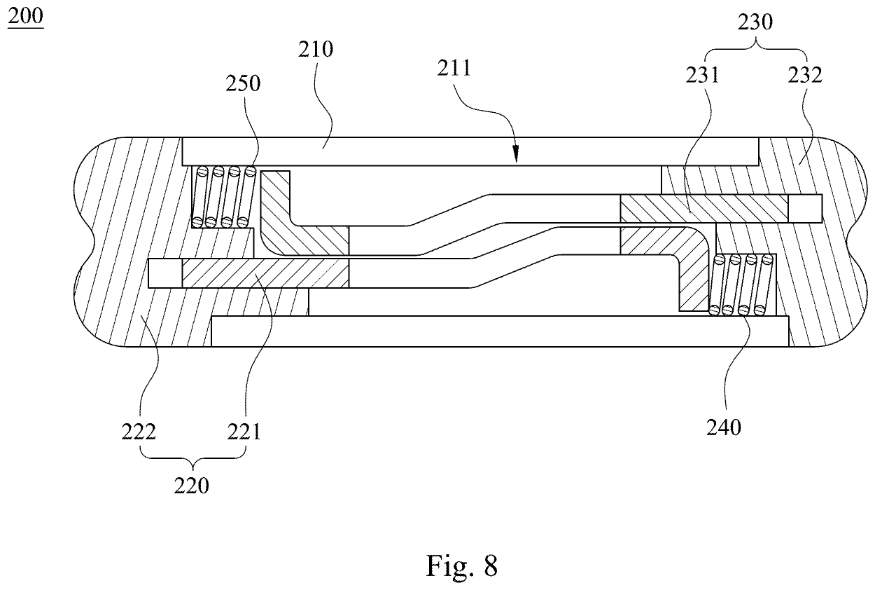

FIG. 8 shows a cross-sectional view of a quick releasing device 200 according to a second embodiment of the present disclosure. In FIG. 8, the quick releasing device 200 includes a housing 210, a first detent structure 220, a second detent structure 230, a first elastic member 240 and a second elastic member 250. The housing 210 has a through hole 211 and two openings. The two openings are located on two sides of the housing 210, respectively. The first detent structure 220 is disposed in the housing 210 and includes a first engaging portion 221 and a first abutting portion 222. The first abutting portion 222 is connected to the first engaging portion 221 and corresponding to one of the two openings of the housing 210. The second detent structure 230 is disposed in the housing 210 and includes a second engaging portion 231 and a second abutting portion 232. The second engaging portion 231 forms an engaging space with the first engaging portion 221. The engaging space is corresponding to the through hole 211. The second abutting portion 232 is connected to the second engaging portion 231 and corresponding to another of the two openings of the housing 210. The first elastic member 240 is telescopically connected between the first engaging portion 221 and the second abutting portion 232. The second elastic member 250 is telescopically connected between the second engaging portion 231 and the first abutting portion 222.

In addition, the first engaging portion 221 and the first abutting portion 222 are assembled into the first detent structure 220, and the second engaging portion 231 and the second abutting portion 232 are assembled into the second detent structure 230, but the present disclosure is not limited thereto. Accordingly, the difficulty of manufacturing the detent structure can be reduced considerably.

In FIG. 8, the structure of the first engaging portion 221 and the second engaging portion 231 is the same as the structure of the first engaging portion 121 and the second engaging portion 131 of FIG. 1, and will not be described again herein.

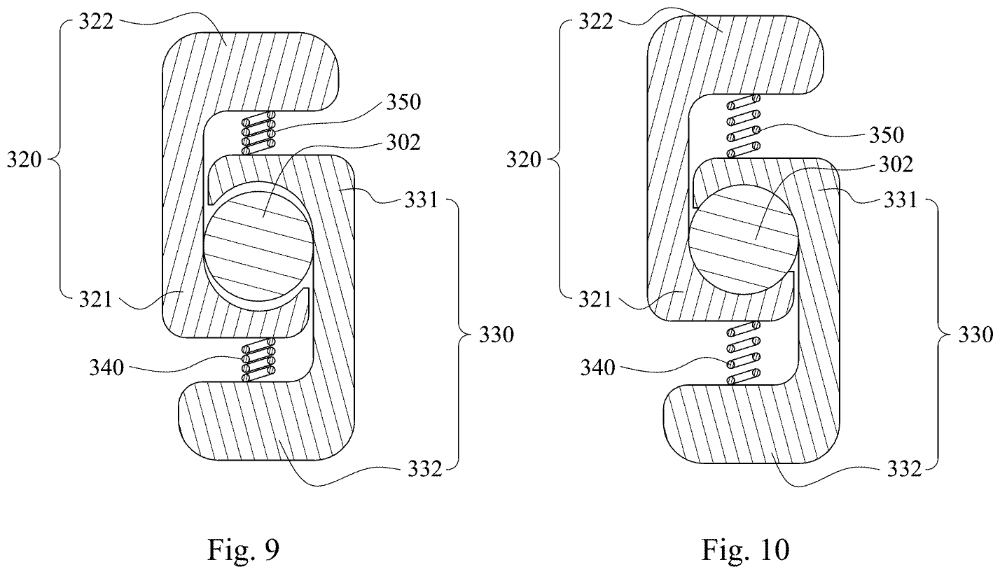

FIG. 9 shows a cross-sectional view of a first detent structure 320, a second detent structure 330, a first elastic member 340 and a second elastic member 350 of a quick releasing device in one operating state according to a third embodiment of the present disclosure. FIG. 10 shows a cross-sectional view of the first detent structure 320, the second detent structure 330, the first elastic member 340 and the second elastic member 350 of FIG. 9 in another operating state. In FIG. 9, the quick releasing device includes a housing, the first detent structure 320, the second detent structure 330, the first elastic member 340 and the second elastic member 350. The structure of the housing, the first elastic member 340 and the second elastic member 350 is the same as the structure of the housing 210, the first elastic member 240 and the second elastic member 250 of FIG. 8, and will not be described again herein.

In FIG. 9, the first detent structure 320 includes a first engaging portion 321 and a first abutting portion 322. The second detent structure 330 includes a second engaging portion 331 and a second abutting portion 332. The second engaging portion 331 forms an engaging space with the first engaging portion 321. The engaging space is corresponding to the through hole of the housing. In detail, the first engaging portion 321 and the first abutting portion 322 are integrally formed to form the first detent structure 320, and the second engaging portion 331 and the second abutting portion 332 are integrally formed to form the second detent structure 330, but the present disclosure is not limited thereto. Therefore, the structural strength of the first detent structure 320 and the second detent structure 330 can be enhanced, and the manufacturing cost can be reduced.

Moreover, in FIG. 9, when the user pushes against the first abutting portion 322 and the second abutting portion 332, the first elastic member 340 and the second elastic member 350 are compressed to increase the relative distance between the first engaging portion 321 and the second engaging portion 331, thereby expanding the engaging space for a target object 302 smoothly passing through the engaging space. In FIG. 10, when the user releases the first abutting portion 322 and the second abutting portion 332, the first engaging portion 321 and the second engaging portion 331 return to another relative position where the first abutting portion 322 and the second abutting portion 332 are not pushed via an elastic restoring force of each of the first elastic member 340 and the second elastic member 350. In other words, the engaging space for the target object 302 engaged between the first engaging portion 321 and the second engaging portion 331 is reduced by decreasing the relative distance between the first engaging portion 321 and the second engaging portion 331. Therefore, the quick releasing device with a simple structure can be stably and quickly engaged with the target object 302 or disassembled from the target object 302.

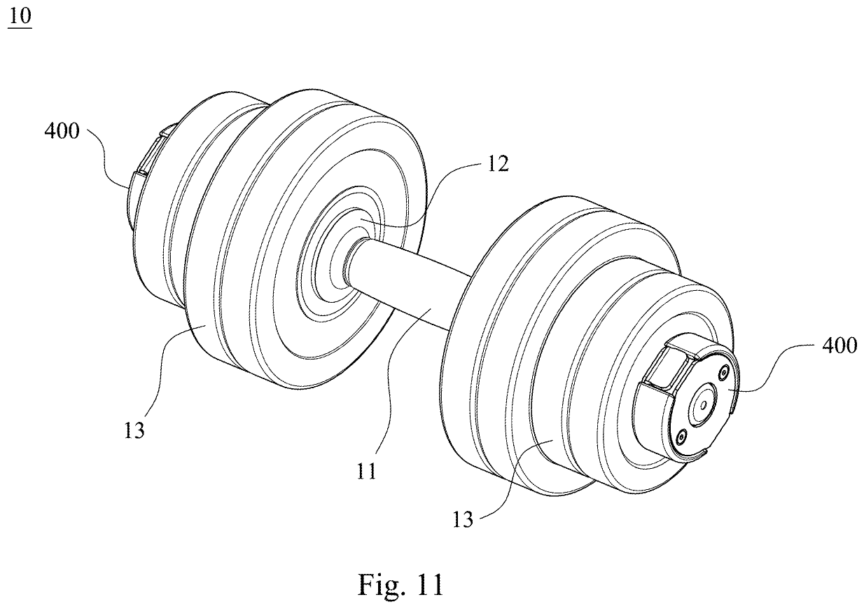

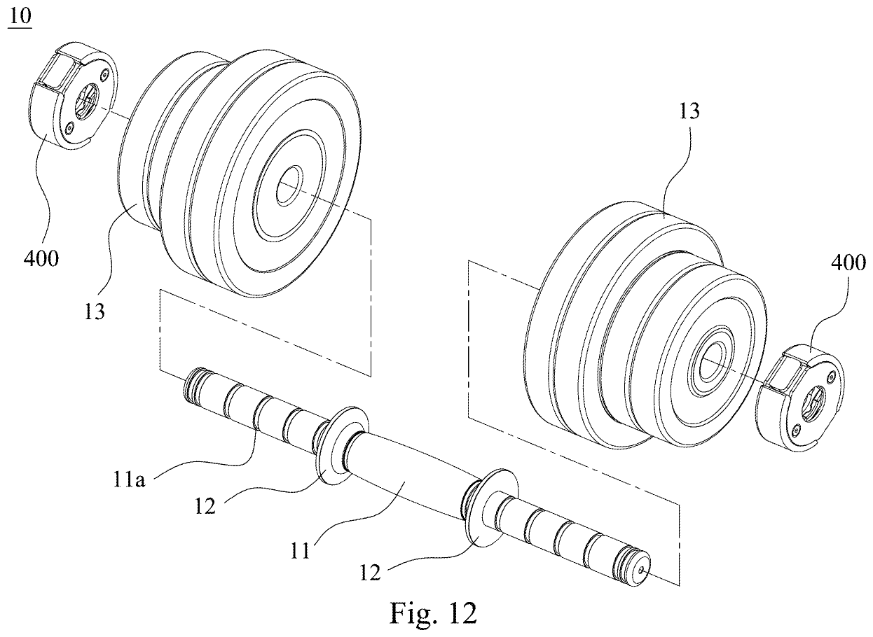

FIG. 11 shows a perspective schematic view of a weight apparatus 10 according to a fourth embodiment of the present disclosure. FIG. 12 shows an exploded view of the weight apparatus 10 of FIG. 11. In FIGS. 11 and 12, the weight apparatus 10 includes a shaft member 11, at least one quick releasing device 400, at least one positioning member 12 and a plurality of weight members 13. The at least one quick releasing device 400 is detachably disposed on the shaft member 11. The at least one positioning member 12 is disposed on the shaft member 11 and corresponding to the at least one quick releasing device 400. The weight members 13 are detachably disposed on the shaft member 11 and located between the at least one positioning member 12 and the at least one quick releasing device 400. The at least one quick releasing device 400 may be the quick releasing device of FIG. 1, FIG. 8 or FIG. 9, but the present disclosure is not limited thereto. The at least one quick releasing device 400 can be disassembled from the shaft member 11 to adjust the number of the weight members 13, and the configuration of the at least one quick releasing device 400 and the at least one positioning member 12 can prevent the weight members 13 from falling off the shaft member 11. Therefore, the load weight of the weight apparatus 10 can be quickly adjusted, and the weight members 13 can be stably positioned on the shaft member 11.

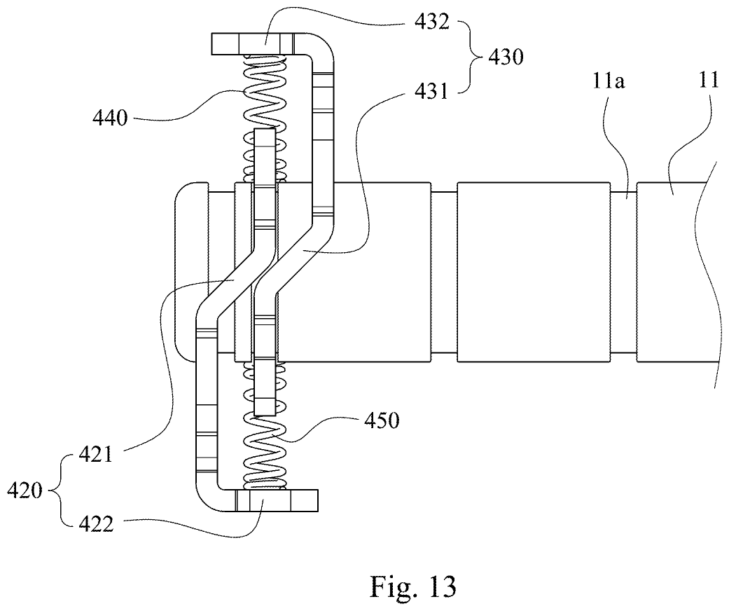

FIG. 13 shows a schematic view of a combination of a first detent structure 420, a second detent structure 430, a first elastic member 440, a second elastic member 450 and a shaft member 11 of FIG. 11. In FIGS. 12 and 13, the quick releasing device 400 includes a housing, the first detent structure 420, the second detent structure 430, the first elastic member 440 and the second elastic member 450. The housing has a through hole and two openings. The two openings are located on two sides of the housing, respectively, and the shaft member 11 is passed through the through hole. The first detent structure 420 includes a first engaging portion 421 and a first abutting portion 422. The second detent structure 430 includes a second engaging portion 431 and a second abutting portion 432. In FIG. 13, the structure of the first detent structure 420, the second detent structure 430, the first elastic member 440 and the second elastic member 450 is the same as the structure of the first detent structure 120, the second detent structure 130, the first elastic member 140 and the second elastic member 150 of FIG. 1, and will not be described again herein. In addition, the shaft member 11 includes a plurality of grooves 11a. The first engaging portion 421 and the second engaging portion 431 of the at least one quick releasing device 400 are movably engaged with one of the grooves 11a. When the user pushes against the first abutting portion 422 and the second abutting portion 432, the at least one quick releasing device 400 is separated from the shaft member 11 and can be displaced on the shaft member 11, thereby adjusting the position of the at least one quick releasing device 400 to one of the grooves 11a. When the user does not push against the first abutting portion 422 and the second abutting portion 432, the first engaging portion 421 and the second engaging portion 431 are engaged with one of the grooves 11a. The configuration of the grooves 11a can prevent the at least one quick releasing device 400 from falling off the shaft member 11 due to an unexpected force. Accordingly, the stability of the at least one quick releasing device 400 engaged with the shaft member 11 can be increased.

In FIG. 11, the number of the at least one quick releasing device 400 is two. The number of the at least one positioning member 12 is two. There are four weight members 13 between each of the two quick releasing devices 400 and each of the two positioning members 12. The size and the weight of each of the weight members 13 can be same or different, and the present disclosure is not limited thereto. Furthermore, the area of the shaft member 11 located between the two positioning members 12 can be covered with a thermoplastic rubber (TPR) layer. The TPR layer is made of a thermoplastic material and can provide a non-slip effect when the user holds the area of the shaft member 11 located between the two positioning members 12. In detail, each of the weight members 13 may include a protective layer which is made of a polyurethane (PU) material to absorb the impact force of the weight members 13 hitting the ground, but the present disclosure is not limited thereto.

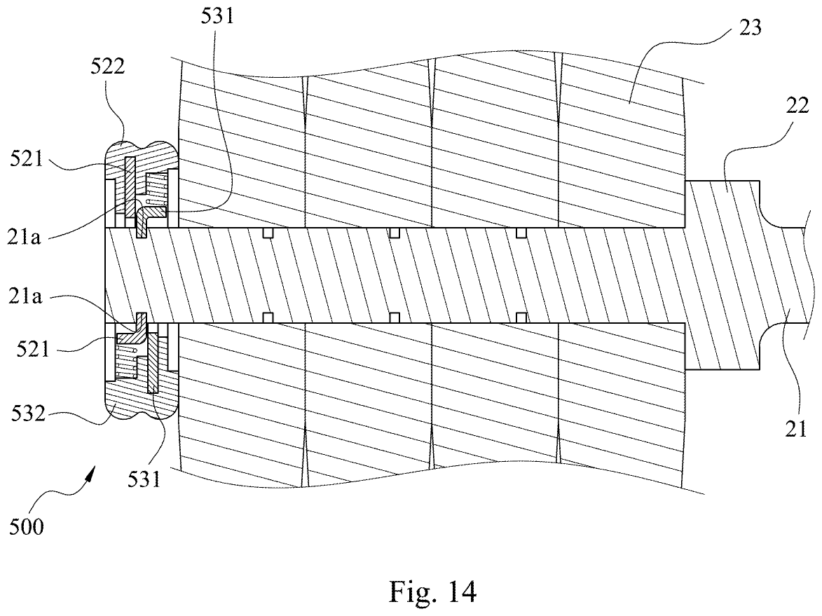

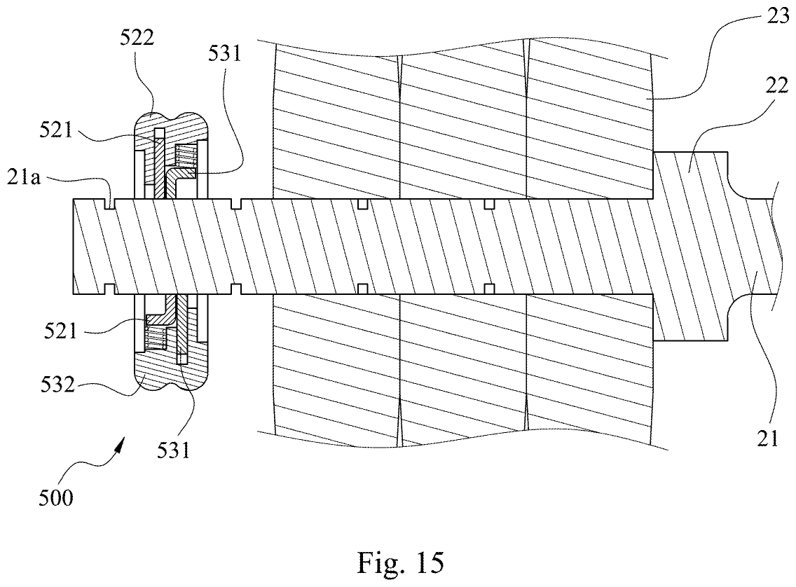

FIG. 14 shows a partial cross-sectional view of a weight apparatus according to a fifth embodiment of the present disclosure. FIG. 15 shows another partial cross-sectional view of the weight apparatus of FIG. 14. In FIGS. 14 and 15, the weight apparatus includes a shaft member 21, at least one quick releasing device 500, at least one positioning member 22 and a plurality of weight members 23. The shaft member 21 includes a plurality of grooves 21a. In FIG. 14, the structure of the shaft member 21, the at least one positioning member 22 and the weight members 23 of the weight apparatus is the same as the structure of the shaft member 11, the at least one positioning member 12 and the weight members 13 of FIG. 11. The structure of the at least one quick releasing device 500 is the same as the structure of the quick releasing device 200 of FIG. 8, and will not be described again herein.

In FIG. 14, when the user does not push against a first abutting portion 522 and a second abutting portion 532 of the at least one quick releasing device 500, a first engaging portion 521 and a second engaging portion 531 of the at least one quick releasing device 500 are engaged with one of the grooves 21a. In FIG. 15, when the user pushes against the first abutting portion 522 and the second abutting portion 532 of the at least one quick releasing device 500, the at least one quick releasing device 500 can be removed from the shaft member 21, and the number of the weight members 23 can be adjusted. Then, the at least one quick releasing device 500 is displaced on the shaft member 21 and engaged with another of the grooves 21a by adjusting the position of the at least one quick releasing device 500, so that the at least one quick releasing device 500 and the at least one positioning member 22 can stably position the weight members 23.

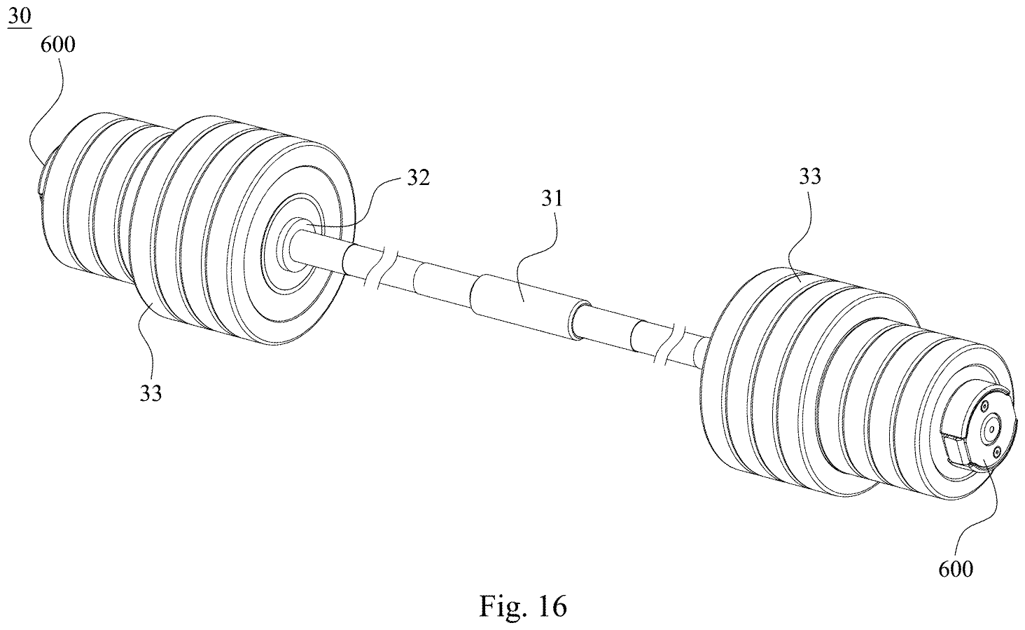

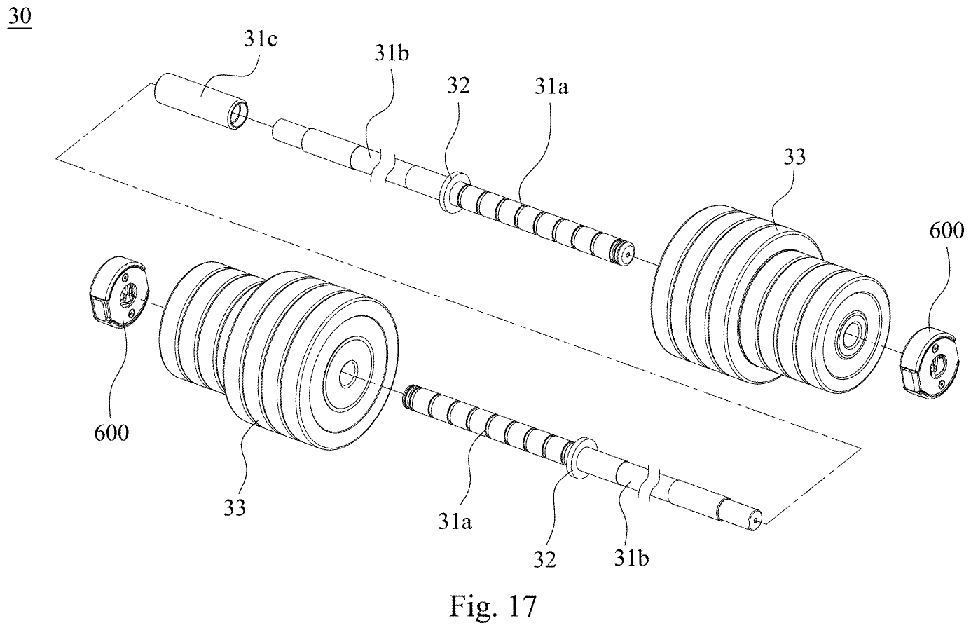

FIG. 16 shows a perspective schematic view of a weight apparatus 30 according to a sixth embodiment of the present disclosure. FIG. 17 shows an exploded view of the weight apparatus 30 of FIG. 16. In FIGS. 16 and 17, the weight apparatus 30 includes a shaft member 31, at least one quick releasing device 600, at least one positioning member 32 and a plurality of weight members 33. The at least one quick releasing device 600 is detachably disposed on the shaft member 31. The at least one positioning member 32 is disposed on the shaft member 31 and corresponding to the at least one quick releasing device 600. The weight members 33 are detachably disposed on the shaft member 31 and located between the at least one positioning member 32 and the at least one quick releasing device 600. The at least one quick releasing device 600 may be the quick releasing device of FIG. 1, FIG. 8 or FIG. 9, but the present disclosure is not limited thereto.

In FIGS. 16 and 17, the shaft member 31 includes a plurality of grooves 31a. A first engaging portion and a second engaging portion of the at least one quick releasing device 600 are movably engaged with one of the grooves 31a. The shaft member 31 may further include at least two connecting rods 31b and at least one connecting member 31c. The at least one connecting member 31c is connected between the at least two connecting rods 31b. The shaft member 31 with different lengths can be formed by connecting the at least one connecting member 31c to the at least two connecting rods 31b according to requirements of the user. Specifically, the number of the at least two connecting rods 31b is two, and the number of the at least one connecting member 31c is one. Therefore, the shaft member 31 with different lengths can be provided.

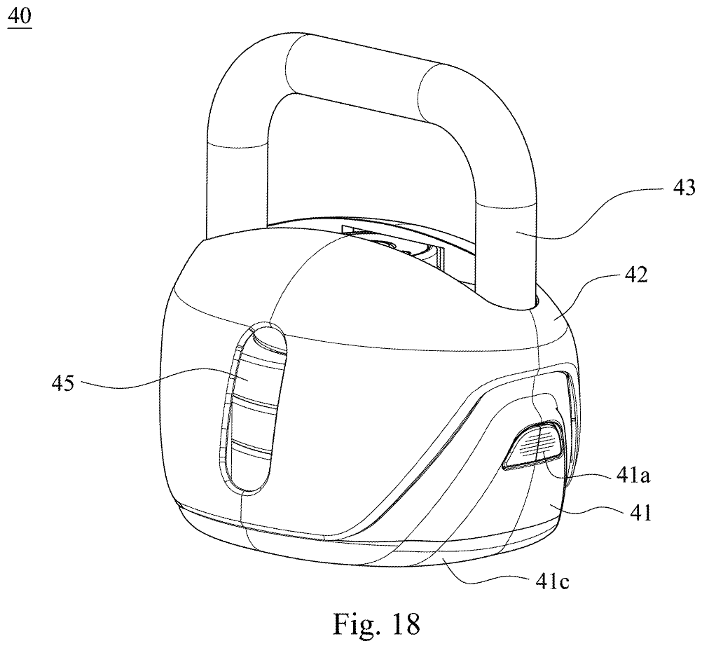

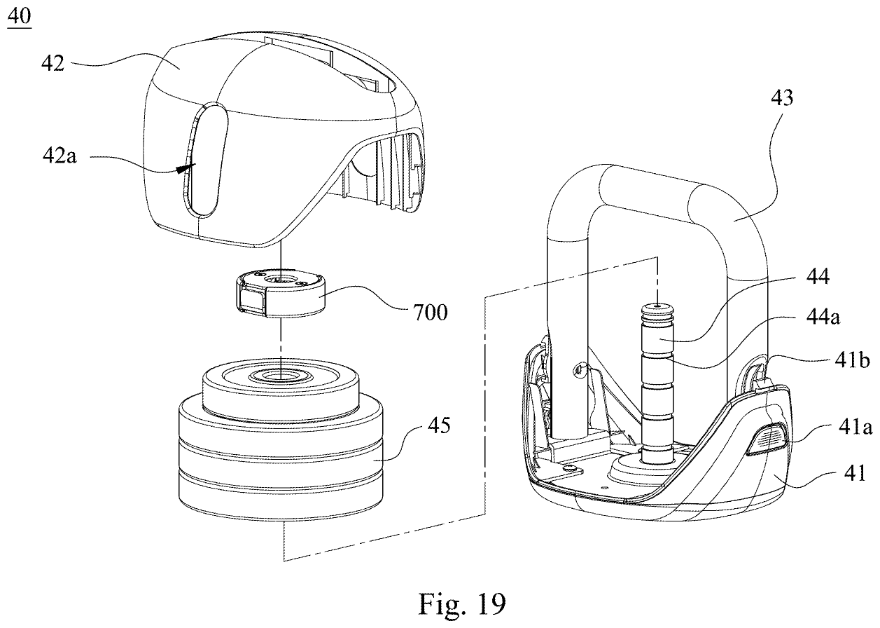

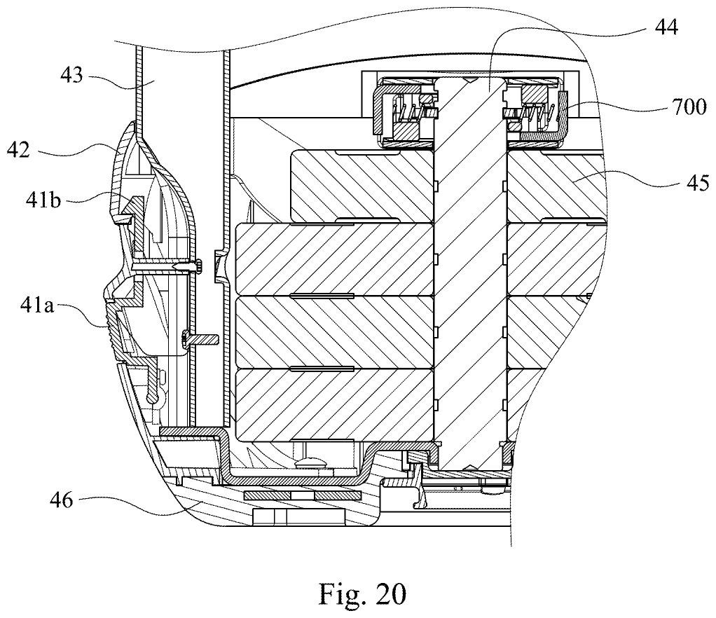

FIG. 18 shows a perspective schematic view of a weight apparatus 40 according to a seventh embodiment of the present disclosure. FIG. 19 shows an exploded view of the weight apparatus 40 of FIG. 18. FIG. 20 shows a partial cross-sectional view of the weight apparatus 40 of FIG. 18. In FIGS. 18 and 19, the weight apparatus 40 includes a base 41, a cover 42, a grip rod 43, a shaft member 44, a quick releasing device 700 and a plurality of weight members 45. The cover 42 detachably covers the base 41 and forms an accommodating space with the base 41. The grip rod 43 is passed through the cover 42 and connected to the base 41. The shaft member 44 is fixed to the base 41 and located in the accommodating space. The quick releasing device 700 is located in the accommodating space and detachably disposed on the shaft member 44. The weight members 45 are located in the accommodating space and detachably disposed on the shaft member 44. The weight members 45 are located between the base 41 and the quick releasing device 700. Specifically, the quick releasing device 700 may be the quick releasing device of FIG. 1, FIG. 8 or FIG. 9, but the present disclosure is not limited thereto. The shaft member 44 is passed through a through hole of a housing of the quick releasing device 700. The quick releasing device 700 can be disassembled from the shaft member 44 to adjust the number of the weight members 45. Therefore, the load weight of the weight apparatus 40 can be quickly adjusted.

In FIG. 18, the cover 42 may include an observation opening 42a, so that it is beneficial to observe the number of the weight members 45 located in the accommodating space.

In FIG. 19, the shaft member 44 includes a plurality of grooves 44a. A first engaging portion and a second engaging portion of the quick releasing device 700 are movably engaged with one of the grooves 44a.

The base 41 can include a push button 41a. The push button 41a is disposed on a side surface of the base 41 and has a wedge-shaped tooth 41b. The wedge-shaped tooth 41b is hooked on the cover 42. Therefore, the user can push the push button 41a to disengage the wedge-shaped tooth 41b from the cover 42, thereby separating the base 41 from the cover 42. Accordingly, it is convenient for the user to adjust the position of the quick releasing device 700 located in the accommodating space and the number of the weight members 45.

In FIGS. 18 and 20, the base 41 can further include a buffer pad 46 made of an elastic material, so that the weight apparatus 40 can be prevented from accidentally hitting the ground to cause damage to the weight apparatus 40 or the ground.

According to the aforementioned embodiments and examples, the advantages of the present disclosure are described as follows.

1. The quick releasing device and the weight apparatus of the present disclosure utilize the detent structures and the elastic members to implement the configuration, so that it is convenient for the user to quickly disassemble the quick releasing device from the target object or move the position of the quick releasing device on the target object.

2. The quick releasing device of the present disclosure can be utilized to adjust the counterweight of the weight apparatus according to the needs of the user.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A quick releasing device, comprising:
a housing having a through hole and two openings, wherein the two openings are located on two sides of the housing, respectively;
a first detent structure disposed in the housing and comprising:
a first engaging portion; and
a first abutting portion connected to the first engaging portion and corresponding to one of the two openings of the housing;
a second detent structure disposed in the housing and comprising:
a second engaging portion forming an engaging space with the first engaging portion, wherein the engaging space is corresponding to the through hole; and
a second abutting portion connected to the second engaging portion and corresponding to another of the two openings of the housing;
a first elastic member telescopically connected between the first engaging portion and the second abutting portion; and
a second elastic member telescopically connected between the second engaging portion and the first abutting portion.

2. The quick releasing device of claim 1, wherein the first engaging portion and the second engaging portion have an inclined structure and are corresponding to each other.

3. The quick releasing device of claim 1, wherein the housing comprises:
two stopping structures, wherein one of the two stopping structures is located between the first abutting portion and the through hole, and another of the two stopping structures is located between the second abutting portion and the through hole.

4. A weight apparatus, comprising:
a shaft member;
at least one quick releasing device detachably disposed on the shaft member and comprising:
a housing having a through hole and two openings, wherein the two openings are located on two sides of the housing, respectively, and the shaft member is passed through the through hole;
a first detent structure disposed in the housing and comprising:
a first engaging portion; and
a first abutting portion connected to the first engaging portion and corresponding to one of the two openings of the housing;
a second detent structure disposed in the housing and comprising:
a second engaging portion forming an engaging space with the first engaging portion, wherein the engaging space is corresponding to the through hole; and
a second abutting portion connected to the second engaging portion and corresponding to another of the two openings of the housing;
a first elastic member telescopically connected between the first engaging portion and the second abutting portion; and
a second elastic member telescopically connected between the second engaging portion and the first abutting portion;
at least one positioning member disposed on the shaft member and corresponding to the at least one quick releasing device; and
a plurality of weight members detachably disposed on the shaft member and located between the at least one positioning member and the at least one quick releasing device.

5. The weight apparatus of claim 4, wherein the shaft member comprises:
a plurality of grooves, wherein the first engaging portion and the second engaging portion of the at least one quick releasing device are movably engaged with one of the grooves.

6. The weight apparatus of claim 4, wherein the shaft member comprises:
at least two connecting rods; and
at least one connecting member connected between the at least two connecting rods.

7. A weight apparatus, comprising:
a base;
a cover detachably covering the base and forming an accommodating space with the base;
a grip rod passed through the cover and connected to the base;
a shaft member fixed to the base and located in the accommodating space;
a quick releasing device located in the accommodating space and detachably disposed on the shaft member, wherein the quick releasing device comprises:
a housing having a through hole and two openings, wherein the two openings are located on two sides of the housing, respectively, and the shaft member is passed through the through hole;
a first detent structure disposed in the housing and comprising:
a first engaging portion; and
a first abutting portion connected to the first engaging portion and corresponding to one of the two openings of the housing;
a second detent structure disposed in the housing and comprising:
a second engaging portion forming an engaging space with the first engaging portion, wherein the engaging space is corresponding to the through hole; and
a second abutting portion connected to the second engaging portion and corresponding to another of the two openings of the housing;
a first elastic member telescopically connected between the first engaging portion and the second abutting portion; and
a second elastic member telescopically connected between the second engaging portion and the first abutting portion; and
a plurality of weight members located in the accommodating space and detachably disposed on the shaft member, wherein the weight members are located between the base and the quick releasing device.

8. The weight apparatus of claim 7, wherein the base comprises:
a push button disposed on a side surface of the base and having a wedge-shaped tooth, wherein the wedge-shaped tooth is hooked on the cover.

9. The weight apparatus of claim 7, wherein the base comprises:
a buffer pad made of an elastic material.

10. The weight apparatus of claim 7, wherein the shaft member comprises:
a plurality of grooves, wherein the first engaging portion and the second engaging portion of the quick releasing device are movably engaged with one of the grooves.
